(19) United States
(12) Patent Application Publication
(10) Pub. No.: US 2022/0289105 A1
(43) Pub. Date: Sep. 15, 2022

(54) Vehicle Access Indicator

(71) Applicant: Breanna L. Bartolucci, Thousand Oaks, CA (US)

(72) Inventor: Breanna L. Bartolucci, Thousand Oaks, CA (US)

(21) Appl. No.: 17/200,815

(22) Filed: Mar. 13, 2021

(51) Int. Cl. B60Q 1/50; B60Q 1/26; G09F 21/04; G09F 7/22

(52) U.S. Cl. CPC B60Q 1/50; B60Q 1/2657; G09F 21/041; G09F 21/048; G09F 7/22; G09F 2007/1865

(57) ABSTRACT

A vehicle access indicator (VAI) that allows a parked vehicle to display a placard showing a message and/or symbol indicating that the parked vehicle transports persons with limited mobility or a large object such as a wheelchair or infant car seat. The VAI comprises an elongated member with the placard at a distal end and securing means. The securing means allow the VAI to be removably or permanently attached to and extend outward from a side of a parked vehicle thereby indicating that minimal extra space is required between the parked vehicle and any other vehicle that parks next to the parked vehicle. Positioning means allow the elongated member and placard to extend perpendicularly straight outward from the side of a vehicle, raised upward or downward, or side-to-side from 0 to 90 degrees.

### TECHNICAL FIELD

The invention generally pertains to vehicle accessories, and more particularly to a vehicle access indicator that provides a visible means of notifying drivers that a vehicle in a parking space requires a certain amount of distance on the vehicle's side for persons or objects to enter and/or exit the parked vehicle.

### BACKGROUND ART

Throughout the developed world, vehicles are the most common form of transportation for both personal and commercial purposes. For individuals and families, cars or variants thereof such as sport utility vehicles (SUVs), are preferred. While there are many varieties there are people who claim that there are too many vehicles in use today and that vehicles are responsible for causing problems such as environmental damage.

Whether vehicles, even single person driven cars, are a detriment, the use does not appear to be lowering. As populations increase and more people raise their living standard, the number of vehicles, particularly cars on the road will also increase.

As the number of and use of cars grows certain problems develop. One problem is that since so many people use cars for daily activities such as shopping there is a need to provide space for parking at the locations to which people drive. Since space is usually limited for parking one solution has been to reduce the size of individual parking spaces and to limit some spaces for use by compact cars. Unfortunately, this is difficult for large trucks or SUVs parked in compact designated spaces.

Because of the smaller parking spaces, vehicles are typically very close to each other. As a result there is often not enough room for adjacent vehicles to open the doors and people to enter or exit their vehicle. This problem is significantly exacerbated when a person has limited mobility or when large and/or cumbersome items such as a wheelchair or baby stroller must be placed into or removed from a vehicle.

In addition to smaller parking spaces, the new convertible car seat for babies is imparting accessibility. These allow the entire infant seat to he removed and placed onto a stroller, thus requiring a car door to be opened even more than before when just loading and unloading a child.

It would be extremely beneficial if there were a way to indicate that a particular vehicle requires extra space on a specific side. Many drivers are conscientious and courteous, and if made aware that a vehicle next to theirs requires additional space, would ensure that their vehicle does not inhibit that. Some vehicles users might require more space for several reason, such as but not limited to, being pregnant and/or having to unload and load a wheelchair or a child's car seat. A simple and effective solution would be to provide a visible indicator on, or preferably extending from, a vehicle that informs other drivers of the space requirement. A visual indicator could be carried within a vehicle and then, used when necessary, could be easily and affordably produced, and could be acquired by almost everyone who would need one. A vehicle access indicator allows all drivers to have a better situational awareness when parking their vehicles.

A search of the prior art did not disclose any literature or patents that read directly on the claims of the instant invention. However, the following U.S. patents are considered related:

| PATENT NO. | INVENTOR | ISSUED |
|---|---|---|
| 4,582,017 | Ostermiller | Apr. 15, 1986 |
| 5,016,145 | Singleton | May 14, 1991 |
| 6,397,504 | McFetridge | Jun. 4, 2002 |
| 2007/0113446 | Shwartz et al | May 24, 2007 |

The U.S. Pat. No. 4,582,017 patent discloses a sporting events flag that includes a fabric flag attached to a flagstaff shaped numeral “1” and a structure for supporting it in use on an automobile.

The U.S. Pat. No. 5,016,145 patent discloses an illuminated display vehicle ornament that an elongated power cord having an adaptor plug for engagement with a vehicle lighter socket. Sockets are spaced along the power cord, and mount replaceable ornamental bulbs. Magnetic, hook and loop, and resilient clips secure the sockets within a vehicle interior. A base includes suction cups for engagement with an interior vehicle window, and a sign is secured to the base. A light bulb is mounted within the base.

The U.S. Pat. No. 6,397,504 patent discloses a method for displaying information in a vehicle window, A display apparatus includes a substantially planar body with a first and a second face. The body has an integrally formed pocket with a transparent viewing window on the first face and second face. A sheet with printed information is inserted into the pocket with the information visible through the viewing widow. The body is inserted into a window well of a vehicle, with the information visible through the widow of the vehicle.

The 2007/0113446 publication discloses a ear decoration which is similar to college flags that are attached to car windows, but instead of a flag there is a three-dimensioned projection reflecting the season (such as devil horns or cat ears for Halloween).

For background purposes and indicative of the art to which the invention relates, reference may be made to the following remaining patents found in the patent search.

| PATENT NO. | INVENTOR | ISSUED |
|---|---|---|
| Des. 264,063 | Ornatek | Apr. 27, 1982 |
| D758,919 | Papp | Jun. 14, 2016 |
| 4,526,820 | Haas | Jul. 2, 1985 |
| 4,791,745 | Pohn | Dec. 20, 1988 |
| 5,069,376 | Barel | Dec. 3, 1991 |
| 5,477,437 | Lach | Dec. 19, 1995 |
| 5,836,261 | Sutton | Nov. 17, 1998 |
| 6,578,300 | Anderson, et al | Jun. 7, 2003 |
| 8,006,419 | Kabalka | Aug. 30, 2011 |
| 9,285,587 | Scofield | Mar. 15, 2016 |

### DISCLOSURE OF THE INVENTION

A vehicle access indicator (VAI) that is comprised of an elongated member such as a rod with a placard on the outward distal end. The placard displays indicia that can show a message and/or a symbol such as Baby on Board™ or the international symbol of access. Removable or permanent securing means facilitate the attachment of the VAI onto a side surface of vehicle. Positioning means allow the elongated member and placard to extend perpendicularly outward from the vehicle's side or to be angled 90 degrees such that the elongated member and placard are against the vehicle, which is an optimal position when the VAI is not in use and when the vehicle is in motion. Also, the user has the ability to remove the VAI and store it inside the vehicle. A break-off section allows the elongated member and placard to separate from the securing means when at least five pounds of pressure is applied to the VAI from any angle.

The preferred, but not limited to, use of the VAI is when a vehicle is transporting certain individuals with mobility issues or objects that are large and/or cumbersome such as a wheelchair or infant car seat. When a vehicle is in a parking space with the VAI extending outward, other drivers, especially those who are parking next to the VAI equipped vehicle, can see on the placard that an additional amount of distance is required on the side(s) of the parked VAI vehicle. By extending the placard outward or applying the removable version of the VAI, a physical indicator shows how much space between parked vehicles is required or at least desired.

In view of the above disclosure the primary object of the invention is to provide a vehicle access indicator that visibly shows drivers that a parked vehicle requires an additional amount of space from other vehicles palled next to the indicated vehicle.

In addition to the primary object of the invention it is also an object of the invention to provide a vehicle access indicator that:
is easy to see,
can be used on a variety of vehicles,
requires no maintenance,
is easy to attach and remove,
can display any message and/or symbol,
does not interfere with the operation of a vehicle,
can be sold as an aftermarket vehicle product or as a boutique item,
is durable and long-lasting, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational rear view showing a vehicle with a vehicle access indicator (VAI) secured to and extending from the passenger side of the vehicle.

FIG. 2 is an elevational view showing a VAI elongated member with a placard displaying indicia at a distal end of the elongated member.

FIG. 3 is an devotional view showing the VAI removable securing means comprised of a suction cup.

FIG. 4 is an elevational view showing the VAI removable securing means comprised of an angled clip.

FIG. 5 is an elevational view showing the VAI removable securing means comprised of an adhesion base.

FIG. 6 is an elevational view showing the VAI removable securing means comprised of a slotted interface.

FIG. 7 is an elevational view showing the slotted interface with a set screw extending through a first vertical section.

FIG. 8 is an elevational view showing the VAI removable securing means comprised of a magnet.

FIG. 9 is an elevational view showing the VAI with a positioning means having a rotatable device to which the VAI elongated member is attached.

FIG. 10 is an elevational view showing the VAI permanent securing means.

### BEST MODE FOR CARRYING OUT THE INVENTION

The best mode for carrying out the invention is presented in terms that disclose a preferred embodiment of a vehicle access indicator. The use of a vehicle for transportation often requires that the vehicle is parked at a desired location such us a retail store. Due to the fact that there are a large and ever increasing number of vehicles, especially personal cars, trucks and sport utility vehicles (SUVs), and that there is only a limited amount of space for parking, it is necessary to provide as many parking spaces as possible in the limited space, with certain parking spaces designated for compact cars. Unfortunately, it is difficult to enforce only compact cars parking in the designated spaces. Also, due to the need to provide as many parking spaces as possible, even non-compact designated parking spaces are typically sized to provide the minimal amount of space necessary.

As a result, cars, trucks and SUVs usually are very close together when parked. This can make entering or exiting a vehicle difficult for an average person, and sometimes impossible for people with mobility difficulties. Also, large or cumbersome items that are transported are often impossible to place into or remove from a parked vehicle.

The VAI offers a solution to this problem by providing visible indication, extending from a parked vehicle, that an extra amount of space is required between the parked vehicle and other vehicles parked next to the vehicle with the VAI. The fact that the VAI extends outward from a parked vehicle allows the VAI to function as a sort-of barrier which another vehicle may impact if parking too close. The VAI will display various messages, images or symbols showing the reason for space requirement, such as, but not limited to an international symbol of access also known as the wheelchair symbol or a message stating baby and stroller on board. While the VAI extending outward as a barrier will typically not cause significant damage to vehicle next to the VAI, any driver parking next to a VAI equipped vehicle will find it impossible to claim he or she did not see the VAI and were unaware of the space requirement.

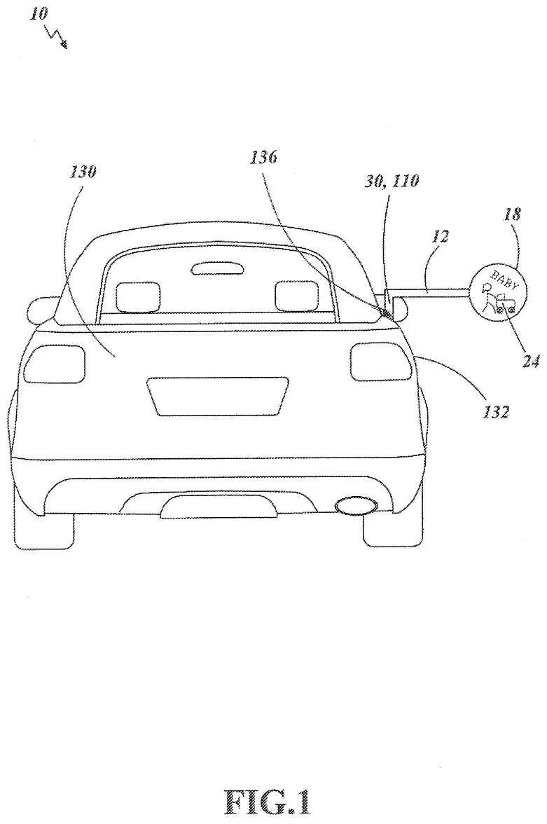

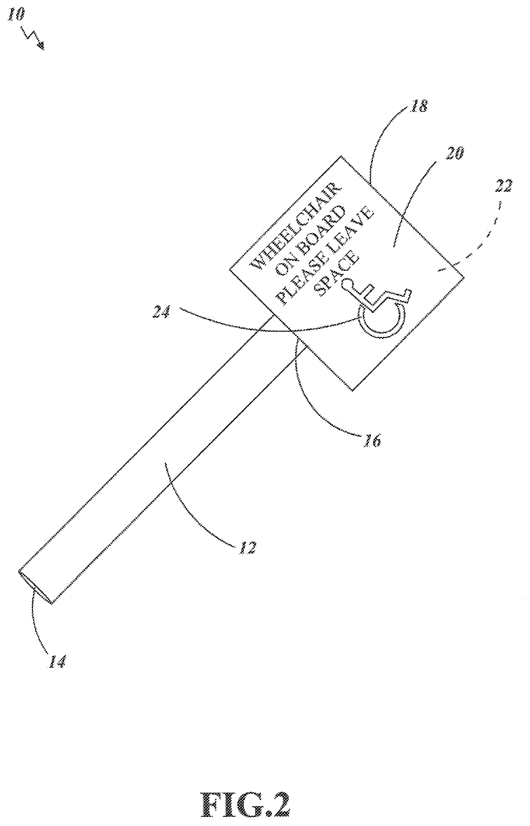

The VAI 10, as shown in FIGS. 1-10, is comprised of two major elements: an elongated member 12 with a placard 18, and a removable 30 or permanent 110 securing means.

The elongated member 12, as shown in FIGS. 1-10, is comprised of a first end 14 and a second end 16. The placard 18 is attached to the distal second end 16. The placard 18 has a first surface 20 and a second surface 22. Either, or both surfaces 20,22 can display indicia 24, which, as previously disclosed, shows a message, image or symbol, or combination thereof. The indicia 24 can be commonly seen images or symbols such as a large “H” or a wheelchair for a handicapped person, or the indicia can show an image of a baby and a stroller. Also, a message can be written such as “Baby and Stroller on Board. Please leave room next to this vehicle”. The elongated member 12 can be made of various materials including plastic, metal or wood, and the member an extend outward to any distance, although realistically a range of 12 inches to 24 inches is preferable. If desired, the elongated member 12 can telescope outward from a first length to a desired second length. The placard 18 can also he made of various materials including plastic, metal, wood, paper/cardboard, or fabric. The placard 18 is either permanently attached to the elongated member 12, or the placard 18 can be temporarily attached allowing one VAI 10 to be used for multiple purposes. The removable attachment is preferably accomplished by use of a slot on the elongated member's 12 end, The slot is dimensioned to allow the placard 18 to he slid into the slot and held by press-fit or other means of retention. Other attachment means can also be utilized such as a low-tack adhesive, double-sided tape or even a magnet (when the elongated member and/or placard is made of metal). Additionally, the indicia 24 can be pre-printed on the placard 18, or the VAI 10 can he provided with a blank placard 18 onto which users can write or draw their own messages, images or symbols, or re-usable or permanent tickers with various messages, images or symbols can be can be made available. To increase the visibility of the placard 18, especially at night or in low-light environments, reflective tape, or reflective printing that will reflect light from a vehicle's headlights can be utilized.

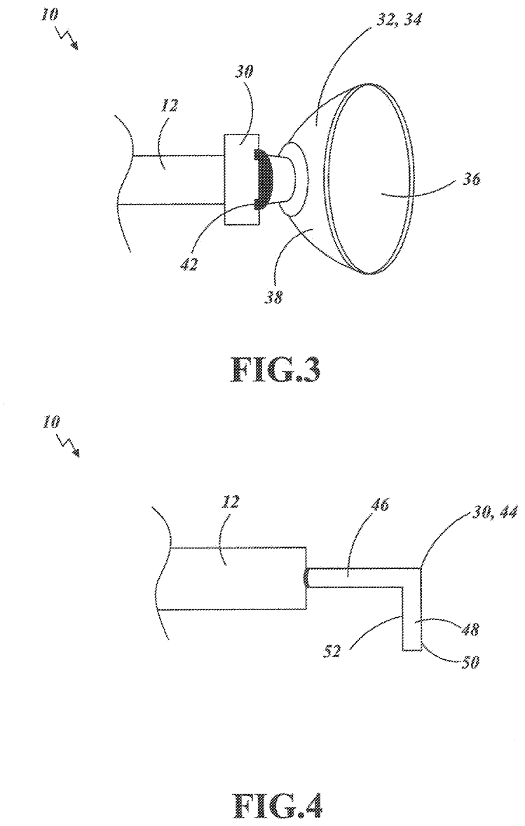

There can be many variations/configurations of the removable securing means 30 including: a suction cup 42, as shown in FIG. 3, with a body 34 made of a resilient material and having an inner concave surface 36 and an outer surface 38. The suction cup 32 can be adhered to any side surface of vehicle, although is most effective on a window, with the elongated member 18 and placard 24 attached by attachment means 42 and extending outward from the outer surface 38. The attachment means 42 can include an adhesive, at least one screw, a pin, or a press-fit slot. It should be noted that the attachment means 42 for attaching the elongated member 12 onto the suction cup 32 can also be utilized for the other variations/configurations of the removable securing means 30.

A second example of the removable securing moans 30 is an angled clip 44, as shown in FIG. 4, and comprised of a horizontal section 46 and a vertical section 48 with an inner end 50 and an outer end 52. The vertical section 48 extends downward from the horizontal section 46 forming a substantial 45 degree angle. The vertical section 48 can be inserted into any viable opening on a side of a vehicle, but is particularly effective when inserted into the opening between the window and the door panel. The elongated member 12 and placard 18 are attached to and extend from the horizontal section 46.

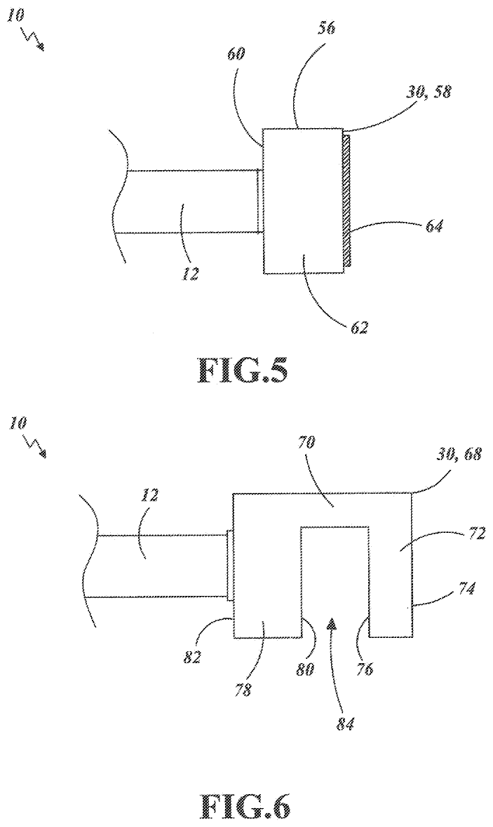

The third example of the removable securing means 3 is an adhesion base 56. As shown in FIG. 5, the adhesion base 56 has an inner surface 58, an outer surface 60 and a perimeter edge 62. The adhesion base 56 is simply a geometric structure, such as a square or circle, with an adhesive, such as non-permanent glue, double-sided tape or hook and loop fastener applied to the inner surface 58, which is then placed at a desired location on the side of a vehicle, The elongated member and placard are attached to and extend from the outer surface 60.

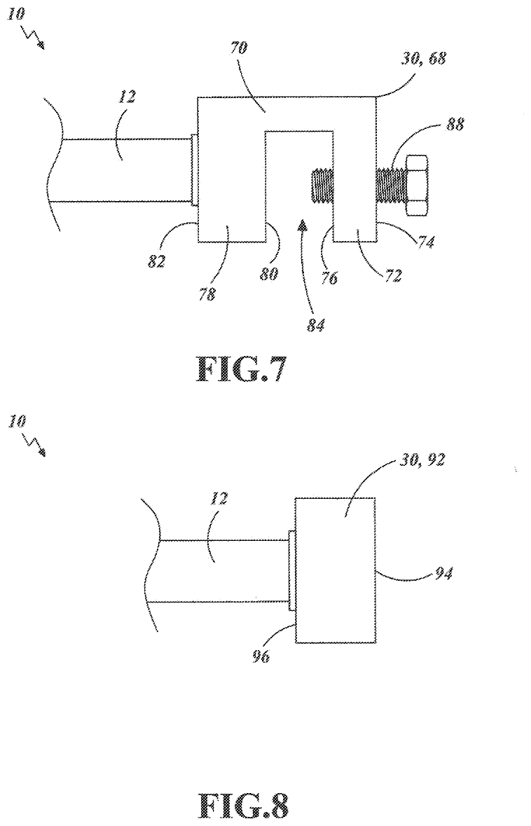

A fourth removable securing means is a slotted interface 68. As shown in FIG. 6, the slotted interface 68 is comprised of a horizontal section 70, a first vertical section 72 with an inner surface 74 and an outer surface 76, a second vertical section 78 with an inner surface 80 and an outer surface 82, and a slot 84 that extends upward between the two vertical sections. The interface 68 is inserted downward into an opening or onto a structural element on a vehicle side surface with a portion of the surface extending into and held within the slot 84. The elongated member and placard are attached to and extend from the horizontal section 70 or the outer surface 82 of the second vertical section 78. In order to better hold the slotted interface 68, a set screw 88 can be utilized, as shown in FIG. 7. The set screw 88 extends through an opening on the interface's first vertical section 72. When the interface 68 is inserted into an opening or onto a structural element the set screw is tightened, thus applying pressure that maintains the interface position.

A fifth and final example of the removable securing means 30 is a magnet 92 with an inner surface 94 and an outer surface 96 as shown in FIG. 8. The magnet's inner surface 94 is placed onto a metal surface such as a door panel or fender on a vehicle's side, with the elongated member attached to and extending from the magnet's outer surface 96.

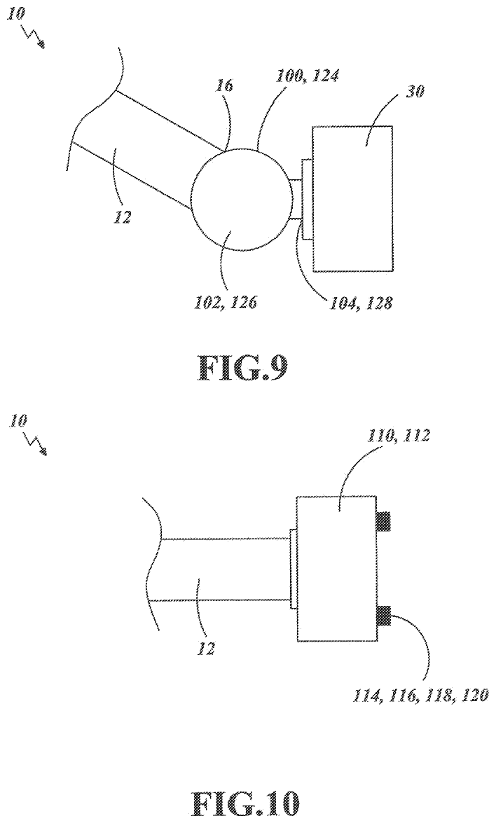

Along with any of the removable securing means 30, a positioning means 100 can be utilized. As shown in FIG. 9, the positioning means 100 comprises a rotatable device 102 and attachment means 104 for attaching the device to the removable securing means 30. The positioning means 100, by use of the rotatable device 102, allows the elongated member and placard to move upwards and or downwards, or side to side thereby positioning the elongated member and placard between 0 to 90 degrees from the securing member 30. The attachment means 104 can include an adhesive, at least one screw, a pin, a tab and slot, or the removable device can be integrally molded along with the removable securing means.

If desired, instead of being removably secured onto a vehicle, the VAI 10 can be permanently secured, which would allow a vehicle manufacturer to implement the VAI 10 as an OEM component of a vehicle. One possible configuration would be to permanently securing only the elongated member 12 to a location such as a longitudinal area along the upper door panel or above the window opening. A removable placard could then be on the elongated member when needed. The permanent securing means 110 preferably would include a base 112 and the attachment means 114 could include an adhesive, at least one screw, at least one bolt and nut or integral molding during the vehicle manufacture. Furthermore, a car manufacturer can automate this VAI for ease of use, similar to way the mirrors fold inward. Additionally. the VAI 10 could be sold as an aftermarket kit for permanent attachment by a vehicle owner. As with the removable securing means 30, the permanent securing means 110 could include the positioning means 124 with the rotatable device 126 and the same attachment means 128 disclosed for the removable securing means 30.

It should be noted that both the removable and permanent securing means are limited examples, there can be numerous other securing means and similar structural designs that follow the inventive design of the VAI 10.

Additionally, in order to provide increased safety and prevent accidents, a break-off section 136, as shown in FIG. 1, is located where the elongated member 12 meets the securing means 30 or attachment means 42. The break-off section 136 causes the elongated member 12 to separate from the securing means 30 or the attachment means 42 when at least five pounds of pressure is applied from any angle to the elongated member 12 or placard 18. This will prevent injury or damage from occurring if, for example a person accidentally walks or runs into the VAI 10, or if a person riding a vehicle such as a bicycle runs into the VAI 10.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A vehicle access indicator (VAI) comprising:
an elongated member comprising:
a first end
a second end,
a placard with a first surface and a second surface,
indicia on at least one of the first and second surfaces, and
removable securing means for securing the VAI onto a side surface of a vehicle such that the elongated member extends outward displaying the indicia on the placard.

2. The vehicle access indicator of claim 1, wherein the elongated member telescopes outward from a first length to an extended second length.

3. The vehicle access indicator of claim 1, wherein the indicia is selected from the group consisting of a warning message, an indicating message, and a symbol.

4. The vehicle access indicator of claim 1, wherein the removable securing means comprises a suction cup to which the elongated member is attached, the elongated member extending outward.

5. The vehicle access indicator of claim 1, wherein the removable securing means comprises a clip including a horizontal section and a downward extending vertical section with an inner surface and an outer surface, wherein the vertical section is inserted into an opening on a side surface of a vehicle, and the elongated member attached to and extends outward from the horizontal section.

6. The vehicle access indicator of claim 1, wherein the removable securing means comprises an adhesion base with an inner surface, an outer surface and a perimeter edge, a non-permanent adhesive applied on the inner surface, a side surface of a vehicle, the elongated member attached to and extending outward from the outer surface.

7. The vehicle access indicator of claim 6, wherein the non-permanent adhesive comprises double-sided tape.

8. The vehicle access indicator of claim 1, wherein the removable securing means comprises a slotted interface with a horizontal section, a first vertical section including a first inner surface and a first outer surface, a second vertical section including a second inner surface and a second outer surface, and an upward extending slot between the two sections, wherein the slotted interface is inserted downward into an opening or onto a structural element on a vehicle side surface with a portion of the vehicle surface extending into and held within the slot, the elongated member attached to and extending outward from the slotted interface.

9. (canceled)

10. The vehicle access indicator of claim 1, wherein the removable securing means comprises of a magnet with an inner surface and an outer surface, wherein the inner surface is configurable for placement onto a metal surface on a side surface of the vehicle, the elongated member attached to and extending outward from the outer surface.

11. The vehicle access indicator of claim 1, wherein the removable securing means is configured for placement on an upper edge of a vehicle window such that when the window is raised, the removable securing means is trapped between the upper edge and upper window body panel.

12. (canceled)

13. (canceled)

14. A vehicle access indicator (VAI) comprising:
an elongated member comprising:
a first end
a second end,
a placard with a first surface and a second surface,
indicia on at least one of the first and second surfaces, and
permanent securing means for securing the VAI onto a side surface of a vehicle such that the elongated member extends outward displaying the indicia on the placard.

15. The vehicle access indicator of claim 14, wherein the indicia is selected from the group consisting of a warning message, an indicating message, a symbol, an advertising message and a promotional message.

16. The vehicle access indicator of claim 14, wherein the permanent securing means comprises a base which is configured with a permanent adhesive, with the base configured to then be placed onto a side surface of a vehicle.

17. The vehicle access indicator of claim 14, wherein the permanent securing means comprises a base having at least one opening through which a screw is inserted and then screwed into a securing means, the securing means comprising a base having at least one opening through which a bolt is inserted and then secured by a nut onto a side surface of a vehicle.

18. The vehicle access indicator of claim 14, wherein the permanent securing means comprises a base having at least one opening through which a bolt is inserted and then secured by a nut onto a side section of a vehicle.

19. The vehicle access indicator of claim 14, wherein the permanent securing means is integrally molded or attached onto a side surface of a vehicle during the manufacture of the vehicle.

20. The vehicle access indicator of claim 14 further comprising a rotatable positioning means and attachment means for attaching die rotatable positioning means to the securing means, and for attaching the elongated member to the rotatable positioning means, wherein the rotatable positioning means facilitates upward and downward or side to side positioning of the elongated member, 0 to 90 degrees from the securing means.

21. The vehicle access indicator of claim 20, wherein the attachment means for attaching the rotatable positioning means to the securing means, and the elongated member to the rotatable positioning means, are selected from the group consisting of an adhesive, at least one screw, a pin, a tab and slot, and integral molding.

22. The vehicle access indicator of claim 14, further comprising a break-off section configured where the elongated member meets the securing means or attachment means, wherein the break-off section causes die elongated member to separate from the securing means or attachment means when at least five pounds of pressure is applied from any angle to the elongated member or placard.
